(19) United States
(12) Patent Application Publication
(10) Pub. No.: US 2025/0387922 A1
(43) Pub. Date: Dec. 25, 2025

(54) ROBOT CONTROL DEVICE, ROBOT, ROBOT CONTROL METHOD

(71) Applicant: CASIO COMPUTER CO., LTD., Tokyo (JP)

(72) Inventors: Kouki MAYUZUMI, Tokyo (JP); Hirokazu HASEGAWA, Tokyo (JP)

(73) Assignee: CASIO COMPUTER CO., LTD., Tokyo (JP)

(21) Appl. No.: 19/242,389

(22) Filed: Jun. 18, 2025

(30) Foreign Application Priority Data
Jun. 24, 2024 (JP) 2024-100957

(51) Int. Cl. B25J 13/08; B25J 9/16; B25J 19/02

(52) U.S. Cl. CPC B25J 13/087; B25J 9/161; B25J 19/026

(57) ABSTRACT

Disclosed is a robot control device including one or more processors configured to: determine whether an action performed by a robot including a sensor that detects an external stimulus has ended; and, in response to an end of the action, cause the sensor to stop a detection operation or cause the sensor to reduce a detection sensitivity for a predetermined time from the end of the action.

### REFERENCE TO RELATED APPLICATIONS

This application claims the priority and benefits of Japanese Patent Application No. 2024-100957, filed on Jun. 24, 2024. The specification, claims, and drawings of Japanese Patent Application No. 2024-100957 are incorporated herein by reference in their entirety.

### TECHNICAL FIELD

The present disclosure relates to a robot control device, a robot, and a method for controlling a robot.

### DESCRIPTION OF RELATED ART

In the past, robots have been known to behave like living beings by detecting external stimuli using sensors such microphones and touch sensors and performing reactive as actions in response to the detected external stimuli. In addition, in order to make robots look more like living beings, a technique has been used in which the main body of the robot is covered with an exterior that resembles fur or the like (e.g., JP 2003-121274A).

### SUMMARY OF THE INVENTION

A robot control device according to the present disclosure comprises one or more processors configured to:

determine whether an action performed by a robot including a sensor that detects an external stimulus has ended; and, in response to an end of the action, cause the sensor to stop a detection operation or cause the sensor to reduce a detection sensitivity for a predetermined time from the end of the action.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an appearance of a robot;

FIG. 2 is a schematic diagram illustrating a configuration of a main body of the robot;

FIG. 3 is a block diagram illustrating a functional configuration of the robot;

FIG. 4 is a schematic cross-sectional view of the robot stored and charged in a power feeder;

FIG. 5 is a diagram illustrating a first detection suppression operation;

FIG. 6 is a flowchart illustrating a control procedure of an action control process;

FIG. 7 is a flowchart illustrating a control procedure of a detection suppression process;

FIG. 8 is a diagram illustrating the first detection suppression operation in a variation;

FIG. 9 is a flowchart illustrating a control procedure of the action control process in the variation; and

FIG. 10 is a flowchart illustrating a control procedure of the detection suppression process in the variation.

### DETAILED DESCRIPTION

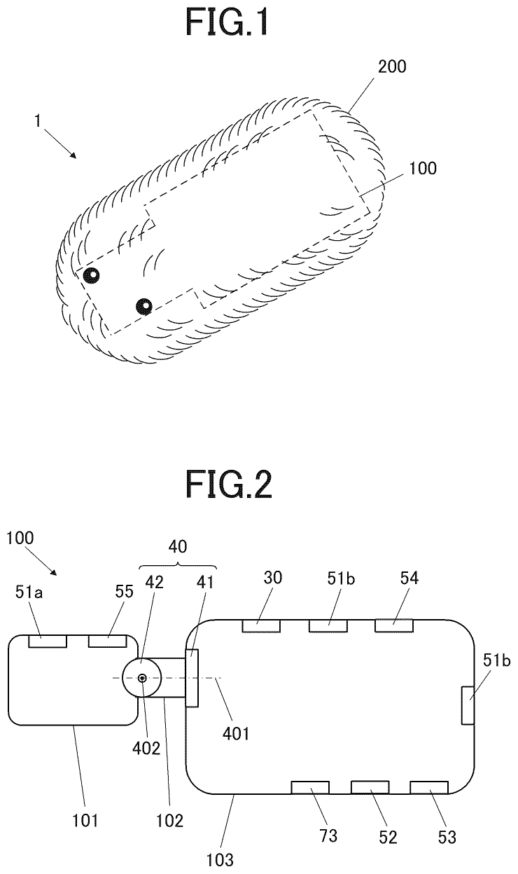

Hereinafter, one or more embodiments according to the present disclosure will be described with reference to the drawings. As illustrated in FIG. 1, a robot 1 includes a main body 100 and an exterior 200 that covers the entire surface of the main body 100. The robot 1 is a pet robot modeled after a small creature. The robot 1 can perform a plurality of different actions that imitate the gestures of a living being. The exterior 200 is made of a flexible material and is deformed in response to the movement of the main body 100. The exterior 200 includes, for example, fur formed from pile fabric, decorative components imitating eyes, and the like. The back of the exterior 200 (the side that comes in contact with the main body 100) includes an engagement portion (not shown) that can be engaged with a fastener (not shown) provided on the surface of the main body 100. By engaging the engagement portion with the fastener, it is possible to prevent the main body 100 and the exterior 200 from being significantly displaced from each other. The number of engagement portions and fasteners is kept to a minimum so that the engagement portions and fasteners do not interfere with the movement of the main body 100 and so that the exterior 200 can be easily attached and detached. In the present embodiment, the engagement portions and fasteners are disposed at a total of three positions, at the left and right eye positions of the robot 1 and at the rear end of the robot 1.

As illustrated in FIG. 2, the main body 100 of the robot 1 includes a head 101, a torso 103, and a connector 102 that connects the head 101 and the torso 103. In the following, a portion of the robot 1 that corresponds to the head 101 will be referred to as a “neck”. The main body 100 includes a drive unit 40 that moves the head 101 relative to the torso 103. That is, in the robot 1, the head 101 corresponds to a “movable portion”. The drive unit 40 includes a twisting motor 41 and an up-and-down movement motor 42. The twisting motor 41 is a servo motor that rotates the head 101 and the connector 102 within a predetermined angle range around a first rotation axis 401 extending in an extending direction of the connector 102. The twisting motor 41 enables the robot 1 to twist the neck. The up-and-down movement motor 42 is a servo motor that rotates the head 101 within a predetermined angle range around a second rotation axis 402 perpendicular to the first rotation axis 401. The up-and-down movement motor 42 enables the robot 1 to move the neck up and down. The up-and-down movement direction of the neck can also be inclined with respect to the vertical direction depending on a twisting angle of the neck by the twisting motor 41. By operating the twisting motor 41 and/or the up-and-down movement motor 42 in a fine, periodic manner, the robot 1 can swing or shake the neck. By suitably changing and combining the timings, amounts, and speeds of the operations of the twisting motor 41 and the up-and-down movement motor 42, it is possible to cause the robot 1 to perform various actions, such as an action of joy, an action of surprise, and a breathing action that imitates the breathing of a living being. Among them, the breathing action is one form of a spontaneous action performed by the robot 1.

As illustrated in FIG. 2, the main body 100 includes a first touch sensor 51a (sensor), second touch sensors 51b (sensors), an acceleration sensor 52, a gyro sensor 53, an illuminance sensor 54, a microphone 55 (sensor), a sound output unit 30, and a power reception coil 73. The first touch sensor 51a is disposed in an upper portion of the head 101. The second touch sensors 51b are disposed in an upper portion and a side surface of the torso 103. Hereinafter, the term “touch sensor 51” is used when referring to any one of the first touch sensor 51a and the second touch sensors 51b. The acceleration sensor 52, gyro sensor 53, and power reception coil 73 are disposed adjacent to a bottom surface of the torso 103. The illuminance sensor 54 and the sound output unit 30 are disposed in the upper portion of the torso 103. The microphone 55 is disposed in the upper portion of the head 101, adjacent to the base of the head 101.

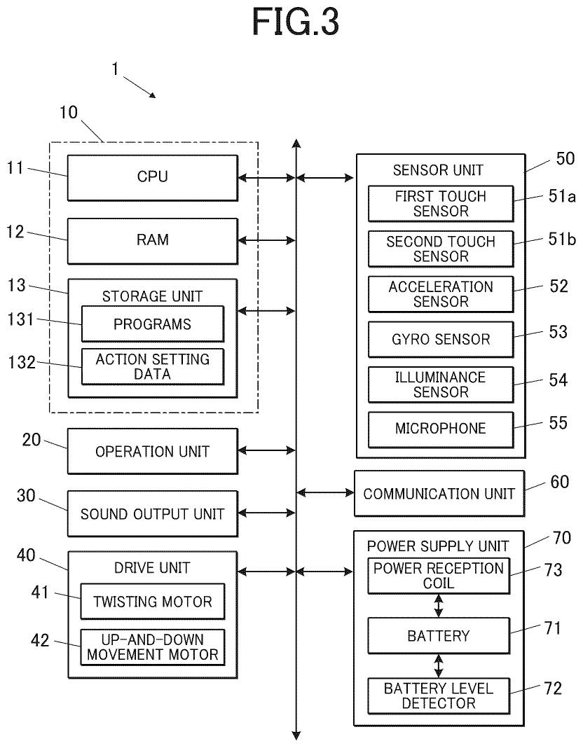

As illustrated in FIG. 3, the robot 1 includes a central processing unit (CPU) 11 (processor), a random-access memory (RAM) 12, a storage unit 13, an operation unit 20, a sound output unit 30, a drive unit 40, a sensor unit 50, a communication unit 60, and a power supply unit 70. The components of the robot 1 are coupled to each other via a data transmission path such as a bus. Each functional configuration illustrated in FIG. 3 is provided in the main body 100. A robot control device 10 that controls the actions of the robot 1 includes the CPU 11, RAM 12, and storage unit 13.

The CPU 11 is a processor that reads and executes programs 131 stored in the storage unit 13 to execute various arithmetic processing, thereby controlling the actions of the robot 1. The robot 1 may include a plurality of processors (e.g., a plurality of CPUs), and the plurality of processors may execute a plurality of processes executed by the CPU 11 according to the present embodiment. In this case, the processor includes the plurality of processors. In addition, the plurality of processors may be involved in a common process, or the plurality of processors may independently execute different processes in parallel. The RAM 12 provides a working memory space for the CPU 11 and stores temporary data.

The storage unit 13 is a non-transitory recording medium readable by the CPU 11 serving as a computer and stores the programs 131 and various data. The storage unit 13 includes, for example, a nonvolatile memory such as a flash memory. Each of the programs 131 is stored in the storage unit 13 in the form of a computer-readable program code. The data stored in the storage unit 13 includes action setting data 132, and the like. The action setting data 132 sets action contents, such as a reactive action that the robot 1 performs in response to the state of the robot 1 or an external stimulus, and an automatically generated action and a breathing action that the robot 1 spontaneously performs regardless of an external stimulus. The automatically generated action can also be called a whimsical action, since the automatically generated action makes it look like the robot 1 is making a gesture on a whim. Settings related to the action contents include, for example, settings of the operation timing and operation amount of the twisting motor 41 and the up-and-down movement motor 42 of the drive unit 40, settings of the pitch, length, and volume of a sound output by the sound output unit 30, and the like.

The operation unit 20 includes operation buttons, operation knobs, and the like for turning the power on and off, as well as for adjusting the volume of a sound output by the sound output unit 30. The operation unit 20 outputs operation information to the CPU 11 according to an input operation on the operation buttons and the operation knobs. The sound output unit 30 includes a speaker and outputs a sound at a pitch, length, and volume corresponding to a control signal and sound data transmitted from the CPU 11. The sound may be a sound that imitates the cry of a living being. The drive unit 40 operates the twisting motor 41 and the up-and-down movement motor 42 according to a control signal transmitted from the CPU 11.

The sensor unit 50 includes the first touch sensor 51a, second touch sensors 51b, acceleration sensor 52, gyro sensor 53, illuminance sensor 54, and microphone 55, and outputs detection results from the respective sensors and the microphone 55 to the CPU 11. Each of the first touch sensor 51a, the second touch sensors 51b, and the microphone 55 corresponds to “a sensor that detects an external stimulus”. The touch sensor 51 detects a contact of a user or another object with the robot 1. The touch sensor 51 includes, for example, a pressure sensor, or a capacitance sensor and outputs detection data regarding the presence or absence of a contact with the robot 1 to the CPU 11. When the touch sensor 51 includes a pressure sensor, the touch sensor 51 outputs the intensity of the contact with the robot 1 to the CPU 11. The touch sensor 51 may detect a pressure equal to or higher than a predetermined first threshold as an external stimulus and may not detect a pressure lower than the first threshold. The first threshold in this case may be changeable by the CPU 11. Increasing the first threshold corresponds to reducing the detection sensitivity of the touch sensor 51 for a contact. The acceleration sensor 52 detects acceleration in each of three orthogonal axial directions and outputs detection data to the CPU 11. The gyro sensor 53 detects angular velocity around each of the three orthogonal axial directions and outputs detection data to the CPU 11. The illuminance sensor 54 detects brightness around the robot 1 and outputs detection data to the CPU 11. The microphone 55 detects a sound around the robot 1 and outputs detected sound data to the CPU 11. The microphone 55 may detect a sound with a volume equal to or higher than a predetermined second threshold as an external stimulus and may not detect a sound with a volume lower than the second threshold. The second threshold in this case may be changeable by the CPU 11. Increasing the second threshold corresponds to reducing the detection sensitivity of the microphone 55 for a sound.

The communication unit 60 is a communication module that includes an antenna, modulation/demodulation circuit, signal processing circuit, and the like, and performs wireless data communication with an external device according to a predetermined communication standard.

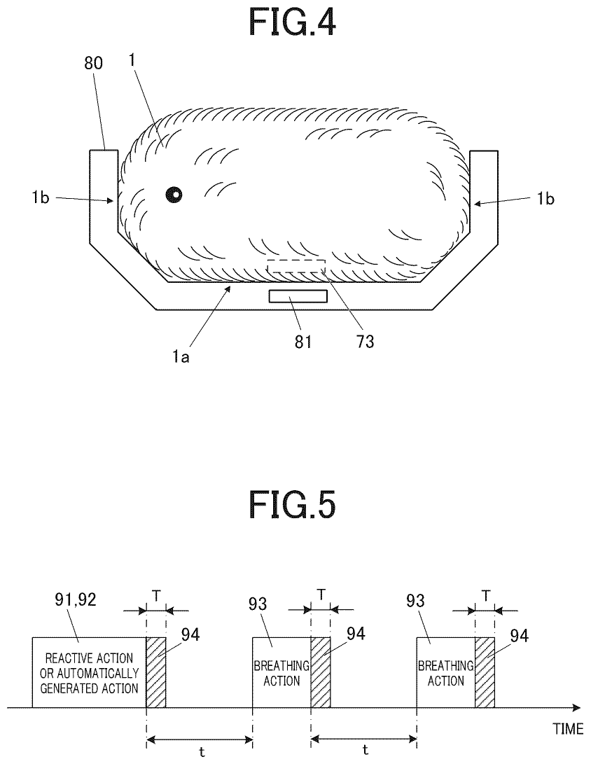

The power supply unit 70 includes a battery 71, a battery level detector 72, and a power reception coil 73. The battery 71 supplies power to each component of the robot 1. The battery 71 according to the present embodiment is a secondary battery that can be repeatedly charged by a non-contact charging method. The battery level detector 72 detects the battery level of the battery 71 according to a control signal transmitted from the CPU 11 and outputs a detection result to the CPU 11. As illustrated in FIG. 4, the battery 71 is charged while the robot 1 is stored (installed) in a dedicated power feeder 80 (holder, charging dock). FIG. 4 illustrates a cross-section of the power feeder 80 and a side view of the robot 1 for descriptive purposes. The power feeder 80 has an appearance modeled after a house of the robot 1. The power feeder 80 is a holder having substantially the same length and width as the outer shape of the robot 1. The power feeder 80 has an opening at the top, and the robot 1 can be taken in and out through the opening. The power feeder 80 has a shape that comes into contact with a bottom surface 1a of the robot 1 and at least a portion of a side surface 1b of the robot 1 when the robot 1 is stored therein. A power transmission coil 81 is disposed in the bottom of the power feeder 80, in a position facing the power reception coil 73 when the robot 1 is stored in the power feeder 80. When the power feeder 80 detects that the robot 1 is stored therein, the power feeder 80 causes an electric current to flow through the power transmission coil 81 to generate a magnetic field. The power reception coil 73 of the robot 1 supplies the battery 71 with an electric current generated by electromagnetic induction in response to the generated magnetic field. In this configuration, when the robot 1 is stored in the power feeder 80, the charging of the battery 71 is automatically started. The method for charging the battery 71 is not limited to the non-contact charging method and may be a contact charging method in which a charging terminal of the robot 1 is brought into contact with a charging terminal of the power feeder 80.

Next, the operation of the robot 1 will be described. When an external stimulus is detected by at least any one of the sensors and the microphone 55 of the sensor unit 50, the CPU 11 causes the robot 1 to perform a reactive action in response to the detected external stimulus. In detail, the CPU 11 identifies which of a plurality of user actions (interactions), such as touching, holding, and speaking has caused the detected external stimulus. Then, the CPU causes the robot 1 to perform a reactive action corresponding to the identified action. That is, the CPU 11 operates the drive unit 40 and causes the sound output unit 30 to output a sound according to the settings of reactive actions. The reactive actions corresponding to respective user actions are preset in the action setting data 132. Among the user actions on the robot 1, the touching or the holding is identified by the touch sensor 51 detecting a contact with the user as an external stimulus. To identify the holding, the detection results of the acceleration and the angular velocity by the acceleration sensor 52 and the gyro sensor 53 may be further referenced. The speaking is identified by the microphone 55 detecting a user's voice as an external stimulus. The CPU 11 may identify a user action by inputting data of the detected external stimulus to a machine learning model (not shown). For example, the machine learning model is provided in the storage unit 13 and is trained by machine learning so as to output a user action in response to receiving detection data of the sensor unit 50. The reactive action may be determined based on the situation of the robot 1 at the time of detecting the external stimulus, in addition to the detection situation of the external stimulus. The situation of the robot 1 may include the brightness of the surroundings based on the detection data of the illuminance sensor 54, whether the robot 1 is stored in the power feeder 80, and the like.

When an external stimulus is not detected by the sensor unit 50 and the execution condition for an automatically generated action is satisfied, the CPU 11 causes the robot 1 to perform a predetermined automatically generated action. The automatically generated action may be an action generated by randomly determining the operation contents of the drive unit 40 and the sound output unit 30 or may be an action for which the operation contents of the drive unit 40 and the sound output unit 30 are preset in the action setting data 132. The execution condition for an automatically generated action may be, for example, that a predetermined action standby time has elapsed since the end of the last performed reactive action or automatically generated action. The action standby time can be set as appropriate but may be a few tens of seconds to a few minutes, for example.

When an external stimulus is not detected by the sensor unit 50, the execution condition for an automatically generated action is not satisfied, and the execution condition for a breathing action is satisfied, the CPU 11 causes the robot 1 to perform the breathing action. The breathing action is, for example, an action of slightly moving the head 101 up and down. The breathing action has a smaller movement of the head 101 than the reactive action and the automatically generated action. The execution condition for a breathing action may be, for example, that a predetermined breathing standby time has elapsed since the end of the last performed reactive action, automatically generated action, or breathing action. The breathing standby time is set to a shorter time than the above-mentioned action standby time, and may be a few seconds to 10 seconds, for example. By causing the robot 1 to perform the breathing action at this frequency, it is possible to make the robot 1 look more like a living being.

Here, since the main body 100 of the robot 1 is covered with the exterior 200, each of the touch sensor 51 and the microphone 55 of the sensor unit 50 detects an external stimulus through the exterior 200. As described above, the exterior 200 is engaged with the main body 100 by the three engagement portions. However, a portion of the exterior 200 other than the engagement portions is free to move with respect to the surface of the main body 100 so as not to interfere with the movement of the main body 100. Therefore, when the head 101 of the main body 100 stops after having been largely moved in a reactive action or an automatically generated action, a portion of the exterior 200 covering the head 101 may be displaced with respect to the surface of the head 101. Such displacement occurs, for example, when a portion of the exterior 200 that has been moved following the movement of the head 101 due to a frictional force slides down the surface of the head 101 due to gravity after the head 101 has stopped moving. Such displacement can also occur when a portion of the exterior 200 in which stress has been generated by the movement of the head 101 moves in a direction that relieves the stress after the head 101 has stopped moving. When such displacement of the exterior 200 occurs, the touch sensor 51 (in particular, the first touch sensor 51a provided in the head 101) may falsely detect the displacement of the exterior 200 as an external stimulus. In addition, when the exterior 200 is displaced, the microphone 55 may falsely detect the sound of the head 101 rubbing against the inner surface of the exterior 200 as an external stimulus. When such a false detection of the touch sensor 51 or the microphone 55 occurs, the robot 1 performs an unnatural reactive action even though there is actually no external stimulus. That is, the robot 1 performs the reactive action corresponding to the touching even though the user has not touched the robot 1, or the robot 1 performs the reaction action corresponding to the speaking even though the user has not spoken to the robot 1.

Therefore, in the present embodiment, the CPU 11 suppresses the detection of the touch sensor 51 and/or the detection of the microphone 55 for a time in which a false detection may occur, depending on the operation state of the robot 1. In detail, the CPU 11 determines the operation state of the robot 1 that involves the movement of the head 101. Then, depending on the determined operation state, the CPU 11 controls at least one of the execution or non-execution of the detection operations of the first touch sensor 51a and the microphone 55 for external stimuli and the detection sensitivities of the first touch sensor 51a and the microphone 55 for external stimuli. Specifically, as illustrated in FIG. 5, when the CPU 11 determines that a reactive action 91 or an automatically generated action 92 (an action) has ended, the CPU 11 executes a “first detection suppression operation 94” to stop the detection operation of the first touch sensor 51a for a contact and the detection operation of the microphone 55 for a sound. The CPU 11 also executes the first detection suppression operation 94 when the CPU 11 determines that a breathing action 93 has ended. In other words, the CPU 11 executes the first detection suppression operation 94 when the CPU 11 determines that the operation state of the robot 1 is a state immediately after the end of the reactive action 91, automatically generated action 92 or breathing action 93. The first detection suppression operation 94 is continued for a predetermined time T from the end of the reactive action 91, the automatically generated action 92, or the breathing action 93. The length of the predetermined time T is set to be longer than the length of the time for which the exterior 200 may be displaced after the head 101 has stopped. For example, the length of the predetermined time T may be set to 0.5 seconds to 1 second. The symbol “t” in FIG. 5 represents the above-described breathing standby time.

In the present embodiment, while the first detection suppression operation 94 is being executed, the detection operation for a contact is continued without reducing the detection sensitivity (i.e., while maintaining the normal sensitivity) of the second touch sensors 51b. This is because the exterior 200 is less likely to be displaced with respect to the torso 103. However, to more reliably suppress a false detection, the detection operations of the second touch sensors 51b for contacts may also be stopped in the first detection suppression operation 94.

While the reactive action 91, automatically generated action 92, or breathing action 93 in FIG. 5 is being performed, the detection operations of the touch sensor 51 and the microphone 55 may be executed in order to receive a user action, or the detection operation of the touch sensor 51 and/or the detection operation of the microphone 55 may be stopped with priority given to the suppression of a false detection of an external stimulus.

A false detection of the microphone 55 may also occur due to a factor other than the rubbing between the exterior 200 and the head 101 caused by the displacement of the exterior 200. For example, when the user pets or holds the robot 1, a rubbing sound of the outer surface of the exterior 200 against the user or a rubbing sound of the exterior 200 against the main body 100 caused by the rubbing between the outer surface of the exterior 200 and the user may be falsely detected as an external stimulus by the microphone 55. As a result, the robot 1 performs the reactive action corresponding to the speaking even though the user has not spoken to the robot 1. In order to suppress a false detection of the microphone 55 due to this cause, in the present embodiment, the CPU 11 stops the detection operation of the microphone 55 for a sound while the touch sensor 51 is detecting a contact. In the following, this operation is referred to as a “second detection suppression operation”.

When the robot 1 performs a reactive action, an automatically generated action, or a breathing action while the robot 1 is stored in the power feeder 80, the exterior 200 rubs against the inner wall of the power feeder 80, generating a sound that causes the microphone 55 to falsely detect the sound as an external stimulus. As a result, the robot 1 performs the reactive action corresponding to the speaking even though the user has not spoken to the robot 1. In order to suppress a false detection of the microphone 55 due to this cause, in the present embodiment, when the robot 1 is stored in the power feeder 80, the CPU 11 reduces the detection sensitivity of the microphone 55 for a sound to a predetermined low sensitivity lower than the normal sensitivity. In other words, the CPU 11 changes the second threshold related to the volume of a sound detected by the microphone 55 to a detection suppression threshold that is higher than the normal threshold. In the following, this operation is referred to as a “third detection suppression operation”. The detection suppression threshold is set to a value higher than the volume of a rubbing sound against the power feeder 80.

Depending on the position of the touch sensor 51, when the robot 1 performs a reactive action, an automatically generated action, or a breathing operation while the robot 1 is stored in the power feeder 80, the touch sensor 51 may falsely detect a contact with the power feeder 80 as an external stimulus. In this case, the CPU 11 may reduce the detection sensitivity of the touch sensor 51 in addition to (or instead of) reducing the detection sensitivity of the microphone 55. In other words, the CPU 11 may change the first threshold related to the pressure of a contact detected by the touch sensor 51 to a detection suppression threshold that is higher than the normal threshold value. The detection suppression threshold is set to a value higher than the pressure of a contact with the power feeder 80.

In the first detection suppression operation 94, instead of stopping the detection operations of the touch sensor 51 and the microphone 55, the detection sensitivities of the touch sensor 51 and the microphone 55 may be reduced. In the second detection suppression operation, instead of stopping the detection operation of the microphone 55, the detection sensitivity of the microphone 55 may be reduced. In the third detection suppression operation, instead of reducing the detection sensitivity of the touch sensor 51 and/or the detection sensitivity of the microphone 55, the detection operation of the touch sensor 51 and/or the detection operation of the microphone 55 may be stopped.

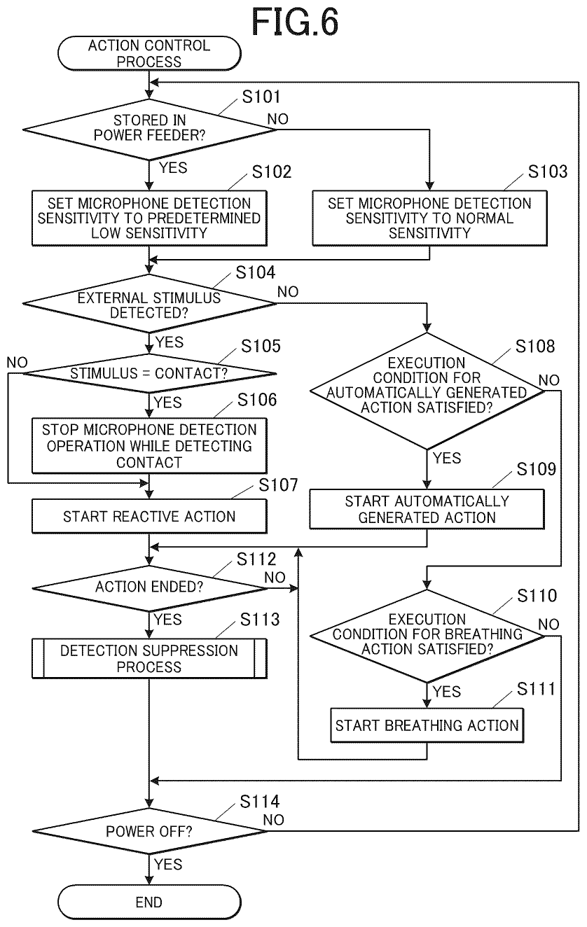

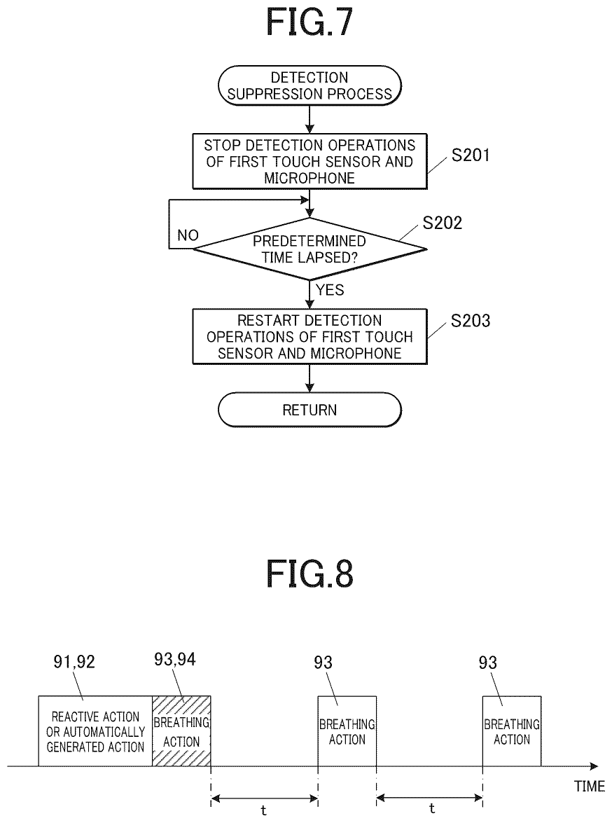

Next, an action control process executed by the CPU 11 in order to realize the above operations will be described with reference to FIGS. 6 and 7. The action control process is started when the robot 1 is powered on to be activated. As illustrated in FIG. 6, when the action control process is started, the CPU 11 determines whether the robot 1 is stored in the power feeder 80 based on the status of the power supply unit 70 (step S101). Here, the CPU 11 determines that robot 1 is stored in the power feeder 80 when the battery 71 is being charged by power from the power reception coil 73. If the CPU determines that the robot 1 is stored in the power feeder 80 (“YES” in step S101), the CPU 11 sets the detection sensitivity of the microphone 55 to the predetermined low sensitivity (step S102). Here, the CPU 11 increases the second threshold related to the volume of a sound detected by the microphone 55 to the detection suppression threshold described above. In other words, the CPU 11 executes the third detection suppression operation described above. On the other hand, if the CPU determines that the robot 1 is not stored in the power feeder 80 (step S101 “NO”), the CPU 11 sets the detection sensitivity of the microphone 55 to the predetermined normal sensitivity (step S103). That is, the CPU 11 sets the second threshold of the microphone 55 to the predetermined normal value.

When step S102 or S103 is completed, the CPU 11 determines whether the sensor unit 50 has detected an external stimulus (step S104). If the CPU 11 determines that the sensor unit 50 has detected an external stimulus (“YES” in step S104), the CPU 11 determines whether the external stimulus is a contact detected by the touch sensor 51 (step S105). If the CPU determines that the detected external stimulus is a contact (“YES” in step S105), the CPU 11 stops the detection operation of the microphone 55 while the touch sensor 51 is detecting the contact (step S106). That is, the CPU 11 executes the second detection suppression operation described above. When step S106 is completed, or when the CPU determines that the external stimulus is not a contact in step S105 (“NO” in step S105), the CPU 11 identifies the user action from the detected external stimulus and starts the reactive action corresponding to the identified action (step S107). Here, the CPU 11 operates the drive unit 40 and causes the sound output unit 30 to output a sound in accordance with the contents of the reactive actions set in the action setting data 132, i.e., the operation timing and operation amount of the twist motor 41 and the up-and-down movement motor 42 of the drive unit 40, and the pitch, length, and volume of a sound output by the sound output unit 30.

On the other hand, if the CPU determines in step S104 that the sensor unit 50 has not detected an external stimulus (“NO” in step S104), the CPU 11 determines whether the execution condition for an automatically generated action is satisfied (step S108). Here, CPU 11 determines that the execution condition for an automatically generated action is satisfied when the predetermined action standby time has elapsed since the end of the last performed reactive action or automatically generated action. If the CPU determines that the execution condition for an automatically generated action is satisfied (“YES” in step S108), the CPU 11 operates the drive unit 40 and causes the sound output unit 30 to output a sound to start the automatically generated action (step S109).

If the CPU determines in step S108 that the execution condition for an automatically generated action is not satisfied (“NO” in step S108), the CPU 11 determines whether the execution condition for a breathing action is satisfied (step S110). Here, CPU 11 determines that the execution condition for a breathing action is satisfied when the predetermined breathing standby time has elapsed since the end of the last performed reactive action, automatically generated action, or breathing action. If the CPU determines that the execution condition for a breathing action is satisfied (“YES” in step S110), the CPU 11 operates the drive unit 40 to start the breathing action (step S111).

When any one of steps S107, S109, or S111 is completed, the CPU 11 repeatedly determines whether the action started in the step has ended (step S112). If the CPU determines that the action has ended (“YES” in step S112), the CPU 11 executes a detection suppression process to execute the first detection suppression operation 94 described above (step S113). As illustrated in FIG. 7, when the detection suppression process is started, the CPU 11 stops the detection operations of the first touch sensor 51a and the microphone 55 (step S201). Thereafter, the CPU 11 repeatedly determines whether the predetermined time T has elapsed (step S202). If the CPU 11 determines that the predetermined time T has elapsed (“YES” in step S202), the CPU 11 restarts the detection operations of the first touch sensor 51a and the microphones 55 (step S203). When step S203 is completed, the CPU 11 ends the detection suppression process and returns the process to the action control process in FIG. 6.

When the detection suppression process (step S113) in FIG. 6 is completed or if the CPU 11 determines in step S110 that the execution condition for a breathing action is not satisfied (“NO” in step S110), the CPU 11 determines whether an operation to turn off the power of the robot 1 has been executed (step S114). If the CPU 11 determines that an operation to turn off the power of the robot 1 has not been executed (“NO” in step S114), the CPU returns the process to step S101. If the CPU 11 determines that an operation to turn off the power of the robot 1 has been executed (“YES” in step S114), the CPU 11 ends the operation control process.

Next, a variation of the above-described embodiment will be described. Hereinafter, differences from the above-described embodiment will be described, and description of what is common to the above-described embodiment is omitted. The present variation differs from the above-described embodiment in the first detection suppression operation 94. In the present variation, as illustrated in FIG. 8, when a reactive action 91 or an automatically generated action 92 ends, a breathing action 93 is performed continuously. While this breathing action 93 is being performed, the detection operations of the first touch sensor 51a and the microphone 55 are stopped. That is, in the present variation, causing the robot 1 to perform the breathing action 93 while the detection operations of the first touch sensor 51a and the microphone 55 are stopped corresponds to the first detection suppression operation 94. In the present variation, the action time of the breathing action 93 that is performed continuously after the reactive action 91 or the automatically generated action 92 corresponds to the “predetermined time”. When a breathing action 93 is performed continuously after the end of a reactive action 91 or an automatically generated action 92, it is possible to induce displacement of the exterior 200 that may occur while the breathing action 93 is being performed. By stopping the detection operations of the first touch sensor 51a and the microphone 55 while the breathing action 93 is being performed, it is possible to prevent a false detection of an external stimulus caused by the induced displacement of the exterior 200.

In a breathing action 93 performed independently, the detection operations of the first touch sensor 51a and the microphone 55 are not stopped. In FIG. 8, the time for which the detection operations of the first touch sensor 51a and the microphone 55 are stopped is hatched. The first detection suppression operation 94 similar to that of the first embodiment may be executed after the end of the breathing action 93 performed independently.

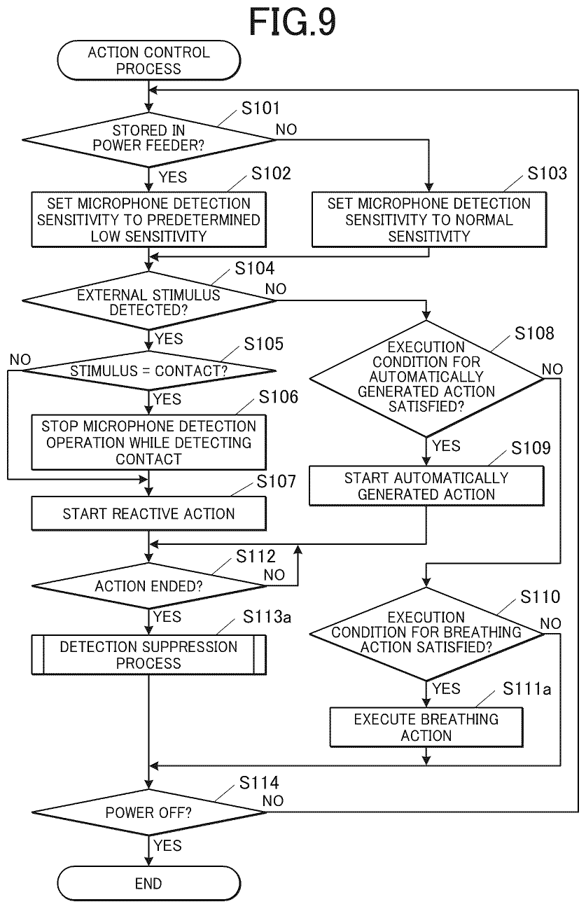

In the present variation, an action control process illustrated in FIG. 9 is executed instead of the action control process illustrated in FIG. 6. The action control process in FIG. 9 corresponds to the action control process in FIG. 6 with steps S111 and S113 changed to steps S111a and S113a, respectively. In step S111a, the CPU 11 causes the robot 1 to perform a breathing action, and after the end of the breathing action, the CPU 11 advances the process to step S114. Therefore, the CPU 11 does not allow a detection suppression process of step S113a to be executed after the end of the breathing action performed independently.

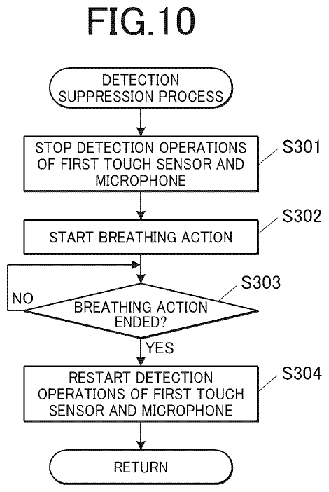

In the detection suppression process of step S113a executed after the end of the reactive action 91 (step S107) or the automatically generated action 92 (step S109), the CPU 11 first stops the detection operations of the first touch sensor 51a and the microphone 55 (step S301), as illustrated in FIG. 10. The CPU 11 also operates the drive unit 40 to start a breathing action (step S302). Thereafter, the CPU 11 repeatedly determines whether the breathing action has ended (step S303). If the CPU 11 determines that the breathing action has ended (“YES” in step S303), the CPU 11 restarts the detection operations of the first touch sensor 51a and the microphone 55 (step S304). (step S304). When step S304 is completed, the CPU 11 ends the detection suppression process and returns the process to the action control process in FIG. 9.

As described above, the robot control device 10 according to the present embodiments controls the robot 1 that includes the touch sensor 51 and the microphone 55 as sensors that detect external stimuli. The robot control device 10 includes the CPU 11. When the CPU 11 determines that a reactive action or an automatically generated action performed by the robot 1 has ended, the CPU 11 causes at least one of the touch sensor 51 and the microphone 55 to stop the detection operation or causes at least one of the touch sensor 51 and the microphone 55 to reduce the detection sensitivity for the predetermined time T from the end of the reactive action or the automatically generated action. Accordingly, when the exterior 200 is in a state of being easily displaced with respect to the main body 100, the detection operations of the touch sensor 51 and the microphone 55 for external stimuli are suppressed (that is, the detection operations are stopped or the detection sensitivities are reduced). This makes it possible to suppress the occurrence of a problem that falsely detects displacement or rubbing of the exterior 200 as an external stimulus. Therefore, it is possible to prevent the robot 1 from performing an unnatural action in response to a false detection of an external stimulus. In other words, in the related art, since it was difficult to make the exterior completely follow the movement of the main body, there were cases where the exterior was rubbed against or displaced with respect to the main body. When such rubbing or displacement of the exterior occurs, there is a problem that the sensor falsely detects the rubbing or displacement as an external stimulus, causing the robot to perform an unnatural action. According to the present disclosure, it is possible to prevent the robot from performing such an unnatural action.

When the CPU 11 determines that a reactive action or an automatically generated action performed by the robot 1 has ended, the CPU 11 stops the detection operation of the microphone 55 for a sound or reduces the detection sensitivity of the microphone 55 for a sound for the predetermined time T from the end of the reactive action or the automatically generated action (first detection suppression operation). Immediately after the end of the reactive action or the automatically generated action, the exterior 200 is likely to be displaced. However, by stopping the detection operation of the microphone 55 after the end of the action as described above, it is possible to suppress the occurrence of a problem in which the microphone 55 falsely detects a sound of the inner surface of the exterior 200 rubbing against the main body 100 as an external stimulus.

When the CPU 11 determines that a reactive action 91 or an automatically generated action 92 performed by the robot 1 has ended, the CPU 11 stops the detection operation of the touch sensor 51 for a contact or reduces the detection sensitivity of the touch sensor 51 for a contact for the predetermined time T from the end of the reactive action or the automatically generated action (first detection suppression operation). By stopping the detection operation of the touch sensor 51 after the end of the action, it is possible to suppress the occurrence of a problem in which the touch sensor 51 falsely detects the displacement of the exterior 200 generated immediately after the end of the reactive action or the automatically generated action as an external stimulus.

The robot 1 includes the head 101 as a movable portion, and a reactive action and an automatically generated action involve the movement of the head 101. After the end of the reactive action or the automatically generated action, the exterior 200 is likely to be displaced. However, by suppressing the detection operations of the touch sensor 51 and the microphone 55 for external stimuli, it is possible to reduce a false detection due to the displacement of the exterior 200.

The sensor includes the first touch sensor 51a that detects a contact with the head 101 as an external stimulus, and the second touch sensors 51b that detect contacts with the torso 103 of the robot 1 other than the head 101 as an external stimulus. When the CPU 11 determines that a reactive action or an automatically generated action performed by the robot 1 has ended, the CPU 11 stops the detection operation of the first touch sensor 51a for a contact or reduces the detection sensitivity of the first touch sensor 51a for a contact for the predetermined time T from the end of the reactive action or the automatically generated action. In the above case, the CPU 11 continues the detection operations of the second touch sensors 51b without reducing the detection sensitivity of the second touch sensors 51b for contacts for the predetermined time T (first detection suppression operation). Thus, by stopping the detection operation of the first touch sensor 51a of the head 101 (movable portion) where the displacement of the exterior 200 is likely to occur, it is possible to effectively reduce false a detection. In addition, by continuing the detection operations of the second touch sensors 51b of the torso 103, it is possible to detect an external stimulus to the torso 103 even while the first detection suppression operation is being executed. This makes it possible for the robot 1 to perform a reactive action in response to a user action such as a touch.

In the variation, when the CPU 11 determines that a reactive action or an automatically generated action performed by the robot 1 has ended, the CPU 11 causes the robot 1 to perform a breathing action for the predetermined time T from the end of the reactive action or the automatically generated action. In a breathing action, the movement of the head 101 is smaller than in a reactive action and an automatically generated action. The CPU 11 causes at least one of the touch sensor 51 and the microphone 55 to stop the detection operation or to reduce the detection sensitivity while the breathing action is being performed (first detection suppression operation). Thus, by causing the robot 1 to perform the breathing action immediately after the end of the reactive action or the automatically generated action, it is possible to induce displacement of the exterior 200 by a natural action to stabilize the exterior 200. By causing the first touch sensor 51a and/or the microphone 55 to stop the detection operation during this breathing action, it is possible to prevent a false detection due to the displacement of the exterior 200 during the breathing action.

While the touch sensor 51 is detecting a contact, the CPU 11 stops the detection operation of the microphone 55 for a sound or reduce the detection sensitivity of the microphone 55 for a sound (second detection suppression operation). This prevents the occurrence of a problem in which the microphone 55 falsely detects a rubbing sound caused by a contact with the touch sensor 51 as an external stimulus.

When the robot 1 is stored in the power feeder 80, the CPU 11 causes the microphone 55 to stop the detection operation for a sound or causes the microphone 55 to reduce the detection sensitivity for a sound (third detection suppression operation). The power feeder 80 has a shape that comes into contact with at least a portion of the robot 1 when the robot 1 is stored therein. This makes it possible to suppress the occurrence of a problem in which the microphone 55 falsely detects a sound generated by the exterior 200 rubbing against the inner wall of the power feeder 80 as an external stimulus when the robot 1 operates while being stored in the power feeder 80.

The robot 1 according to the present embodiments includes the robot control device 10 and the touch sensor 51 and the microphone 55 as sensors. This makes it possible to prevent the robot 1 from performing an unnatural action due to a false detection of displacement or rubbing of the exterior 200 as an external stimulus.

The robot 1 includes the main body 100 that includes the touch sensor 51 and the microphone 55, and the exterior 200 that covers at least a portion of the main body 100 where the touch sensor 51 and the microphone 55 are provided. In the robot 1 provided with such an exterior 200, displacement or rubbing of the exterior 200 is likely to be falsely detected as an external stimulus. However, by executing the above-described detection suppression operation, it is possible to prevent the robot 1 from performing an unnatural action.

In a method for controlling the robot 1 according to the present embodiments, the CPU 11 determines as to whether a reactive action or an automatically generated action performed by the robot 1 has ended, and, in response to the end of the reactive action or the automatically generated action, causes at least one of the touch sensor 51 and the microphone 55 to stop the detection operation or causes at least one of the touch sensor 51 and the microphone 55 to reduce the detection sensitivity for the predetermined time T from the end of the reactive action or the automatically generated action. The storage unit 13 as a computer-readable non-transitory recording medium according to the present embodiments stores the programs 131. The programs 131 cause the CPU 11 of the robot control device 10 to execute the action control process. The action control process includes: determining as to whether a reactive action or an automatically generated action performed by the robot 1 has ended; and, in response to the end of the reactive action or the automatically generated action, causing at least one of the touch sensor 51 and the microphone 55 to stop the detection operation or causing at least one of the touch sensor 51 and the microphone 55 to reduce the detection sensitivity for the predetermined time T from the end of the reactive action or the automatically generated action. This makes it possible to prevent the robot 1 from performing an unnatural action.

The present disclosure is not limited to the above embodiments, and various modifications are possible. For example, an example in which the robot 1 includes the exterior 200 from the beginning has been described, but the present disclosure is not limited thereto. For example, when a user attaches an exterior that mimics clothing or an exterior that protects the main body 100 to the robot 1 that includes only the main body 100, a false detection by the touch sensor 51 or microphone 55 can be suppressed by executing the same detection suppression process as in the above embodiments.

In addition, an example in which the exterior 200 covers the entire surface of the main body 100 has been described, but the present disclosure is not limited thereto. The exterior 200 only needs to cover at least a portion of the main body 100 where the touch sensor 51 and the microphone 55 are provided.

In the above embodiments, each of the touch sensor 51 and microphone 55 is exemplified as a sensor, but the sensor is not limited thereto. The sensor may be any device capable of detecting an external stimulus.

The breathing action is exemplified as a spontaneous action with less movement of the movable portion than the reactive and automatically generated actions, but the spontaneous action is not limited thereto. The spontaneous action may also include another action that imitates the robot 1 sleeping or resting, for example.

The power feeder 80 is exemplified as a holder, but the holder is not limited thereto. The holder may be any component capable of storing the robot 1. That is, the holder may not necessarily be a component for charging the battery 71.

The configuration of the robot 1 is not limited to the configuration illustrated in FIGS. 1 to 3. For example, a robot imitating an existing living being such as a person, an animal, a bird, or fish, a robot imitating a non-existing living being such as a dinosaur, a robot imitating an imaginary living being, or the like may be used.

In the above embodiments, the robot control device 10 that controls the robot 1 is disposed inside the robot 1 is exemplified, but the present disclosure is not limited thereto. The robot 1 may be controlled and operated by a robot control device disposed outside the robot 1. The external robot control device may include, for example, a smartphone, a tablet device, or a laptop. In this case, the robot 1 is operated according to a control signal received from the external robot control device via the communication unit 60. The external robot control device executes the functions executed by the robot control device 10 in the above embodiments.

In the above description, an example has been disclosed in which a flash memory is used for the storage unit 13 as a computer-readable medium storing the programs according to the present disclosure, but the present disclosure is not limited thereto. As another computer-readable medium, an information recording medium such as a hard disk drive (HDD), a solid-state drive (SSD) or a CD-ROM may be applied. A carrier wave is also applied to the present disclosure as a medium that provides data of the programs according to the present disclosure via a communication line.

The detailed configuration and the detailed operation of each component of the robot 1 in the above embodiments can be appropriately changed without departing from the gist of the present disclosure.

Although the embodiments according to the present disclosure have been described, the scope of the present disclosure is not limited to the above-described embodiments and includes the scope of the invention as described in the claims and equivalents thereof.

1. A robot control device comprising one or more processors configured to:
determine whether an action performed by a robot including a sensor that detects an external stimulus has ended; and,
in response to an end of the action, cause the sensor to stop a detection operation or cause the sensor to reduce a detection sensitivity for a predetermined time from the end of the action.

2. The robot control device according to claim 1, wherein
the sensor includes a microphone that detects a sound as the external stimulus, and,
in response to the end of the action, the one or more processors cause the microphone to stop the detection operation for the sound or cause the microphone to reduce the detection sensitivity for the sound for the predetermined time from the end of the action.

3. The robot control device according to claim 1, wherein
the sensor includes a touch sensor that detects a contact with the robot as the external stimulus, and,
in response to the end of the action, the one or more processors cause the touch sensor to stop the detection operation for the contact or cause the touch sensor to reduce the detection sensitivity for the contact for the predetermined time from the end of the action.

4. The robot control device according to claim 1, wherein
the robot includes a movable portion, and
the action involves movement of the movable portion.

5. The robot control device according to claim 4, wherein:
the sensor includes
a first touch sensor that detects a contact with the movable portion as the external stimulus and
a second touch sensor that detects a contact with a portion of the robot other than the movable portion as the external stimulus; and,
in response to the end of the action, the one or more processors
cause the first touch sensor to stop the detection operation for the contact or cause the first touch sensor to reduce the detection sensitivity for the contact for the predetermined time from the end of the action, and
cause the second touch sensor to continue the detection operation for the contact without reducing the detection sensitivity for the contact for the predetermined time.

6. The robot control device according to claim 4, wherein:
the sensor includes at least one of a microphone that detects a sound as the external stimulus or a touch sensor that detects a contact with the robot as the external stimulus; and,
in response to the end of the action, the one or more processors
cause the robot to perform a spontaneous action with less movement of the movable portion than the action for the predetermined time from the end of the action, and,
while the spontaneous action is being performed, cause the at least one of the microphone or the touch sensor to stop the detection operation or cause the at least one of the microphone or the touch sensor to reduce the detection sensitivity.

7. The robot control device according to claim 1, wherein:
the sensor includes
a microphone that detects a sound as the external stimulus and
a touch sensor that detects a contact with the robot as the external stimulus; and,
while the touch sensor is detecting the sound, the one or more processors cause the microphone to stop the detection operation for the sound or cause the microphone to reduce the detection sensitivity for the sound.

8. The robot control device according to claim 1, wherein:
the sensor includes a microphone that detects a sound as the external stimulus;
the one or more processors cause the microphone to stop the detection operation for the sound or cause the microphone to reduce the detection sensitivity for the sound when the robot is stored in a predetermined holder; and
the holder has a shape that comes into contact with at least a portion of the robot when the robot is stored in the holder.

9. A robot comprising:
the robot control device according to claim 1; and
the sensor.

10. The robot according to claim 9, further comprising
a main body that includes the sensor, and
an exterior that covers at least a portion of the main body, the sensor being disposed in the portion.

11. A method for controlling a robot, comprising:
determining whether an action performed by the robot including a sensor that detects an external stimulus has ended; and,
in response to an end of the action, causing the sensor to stop a detection operation or causing the sensor to reduce a detection sensitivity for a predetermined time from the end of the action.
